(19) United States
(12) Patent Application Publication
(10) Pub. No.: US 2025/0319709 A1
(43) Pub. Date: Oct. 16, 2025

(54) INKJET PROCESSING LINE FOR ARTIFICIAL STONES

(71) Applicant: VEEGOO TECHNOLOGY CO., LTD., Foshan (CN)

(72) Inventors: Yeheng QIU, Foshan (CN); Jianqing DENG, Foshan (CN); Luyang TONG, Foshan (CN)

(21) Appl. No.: 19/060,857

(22) Filed: Feb. 24, 2025

Related U.S. Application Data
(63) Continuation of application No. PCT/CN2025/078024, filed on Feb. 19, 2025.

(30) Foreign Application Priority Data
May 30, 2024 (CN) 202421226410.3

(51) Int. Cl. B41J 13/08; B41J 3/407; B41J 11/00; B41J 13/10; B41J 13/22; B41J 29/377

(52) U.S. Cl. CPC B41J 13/08; B41J 3/4073; B41J 11/0022; B41J 11/0024; B41J 13/103; B41J 13/106; B41J 13/22; B41J 29/377

(57) ABSTRACT

An artificial stone inkjet processing line includes a centering device, an inkjet printing device, a drying device and a cooling device. The drying device includes a conveying assembly, a heating box including a transition station, and a placement mechanism. Two ends of the transition station face towards the inkjet printing device and the placement mechanism, respectively. The conveying assembly is provided at the transition station. An inlet of a conveying end of the conveying assembly is arranged close to an outlet of a conveying end of the inkjet printing device. A conveying end of the placement mechanism is adjusted to align with an outlet of the conveying end of the conveying assembly, a storage station at a side of the heating box, or an inlet of a conveying end of the cooling device, and can reciprocate between the heating box and the cooling device.

### CROSS-REFERENCE TO RELATED APPLICATIONS

This application is a continuation of International Patent Application No. PCT/CN2025/078024, filed on Feb. 19, 2025, which claims the benefit of priority from Chinese Patent Application No. 202421226410.3, filed on May 30, 2024. The content of the aforementioned application, including any intervening amendments thereto, is incorporated herein by reference in its entirety.

### TECHNICAL FIELD

This application relates to artificial stone processing, and more particularly to an inkjet processing line for artificial stones.

### BACKGROUND

Artificial quartz stone includes more than 90% of natural quartz and about 10% of pigment, resin and additives for bonding and curing, and is usually processed into a plate through vacuum high-frequency vibration molding and thermal curing (the curing temperature is determined according to the type of the selected curing agent). The artificial quartz stone is hard (with a Moh's hardness of 5-7) and structurally compact (with a density of 2.3 g/cm³), and has superior wear resistance, pressure resistance, high temperature resistance, corrosion resistance, and anti-penetration performance than other decorative materials.

In the prior art, the artificial quartz plate is generally treated by inkjet to improve its appearance. Different ink materials are often adopted for different types of artificial quartz plates, and different ink materials vary in the curing temperature. For example, some inks are cured at room temperature, while some inks are cured under an elevated temperature. Therefore, in the case that two curing methods are needed in the processing line, some artificial quartz plates during the thermal curing will block subsequent artificial quartz plates that do not need heating, which will reduce the processing efficiency of the artificial quartz plates.

### SUMMARY

An object of this application is to provide an artificial stone inkjet processing line, where an artificial stone is centered and positioned by a centering device, printed through an inkjet printing device, dried in a heating box, and then transferred to a placement mechanism through a conveying assembly at a transition station; and after receiving the artificial stone, the placement mechanism approaches the heating box or a cooling device, and outputs the artificial stone thereto.

Technical solutions of this application are described as follows.

An inkjet processing line for artificial stones is provided, comprising:
a centering device;
an inkjet printing device;
a drying device; and
a cooling device;
wherein the centering device, the inkjet printing device, the drying device and the cooling device are arranged in sequence along a conveying direction of an artificial stone;
the inkjet printing device is configured to perform inkjet printing; the centering device comprises a first conveying end and a second conveying end; the first conveying end is configured to face towards the inkjet printing device, and a conveying direction of the first conveying end is perpendicular to a conveying direction of the second conveying end;
the drying device comprises a first conveying assembly, a heating box and a placement mechanism; and
the heating box is provided with a transition station with two hollow ends; and a one of the two hollow ends of the transition station is configured to face towards the inkjet printing device, and the other of the two hollow ends of the transition station is configured to face towards the placement mechanism;
a side of the heating box towards the placement mechanism is provided with a storage station;
the first conveying assembly is provided at the transition station; an inlet of a conveying end of the first conveying assembly is arranged close to an outlet of a conveying end of the inkjet printing device; and
a conveying end of the placement mechanism is configured to be adjusted to align with an outlet of the conveying end of the first conveying assembly, the storage station or an inlet of a conveying end of the cooling device, and the conveying end of the placement mechanism is configured to reciprocate between the heating box and the cooling device.

In an embodiment, the inkjet processing line further comprises a pre-treating device;
wherein the pre-treating device, the centering device, the inkjet printing device, the drying device and the cooling device are arranged in sequence; and
the pre-treating device is provided with a pre-treating chamber; and a heating mechanism and an impurity-removing mechanism are provided in the pre-treating chamber.

In an embodiment, the centering device comprises a centering base, a second conveying assembly, a lifting assembly and a first driving assembly;
the second conveying assembly is arranged on the centering base; the second conveying assembly has at least two conveying ends facing towards the inkjet printing device; and the at least two conveying ends of the second conveying assembly are spaced apart from each other, such that a gap is formed between adjacent two of the at least two conveying ends of the second conveying assembly; and
the lifting assembly and the first driving assembly are arranged within the gap; a conveying end of the lifting assembly is connected with the first driving assembly, and is configured to drive the first driving assembly to rise to a position above or below the at least two conveying ends of the second conveying assembly; a conveying end of the first driving assembly is configured to extend laterally, and is perpendicular to the at least two conveying ends of the second conveying assembly; and the centering base comprises a positioning component, and the positioning component is arranged at an outlet of the conveying end of the first driving assembly.

In an embodiment, the second conveying assembly comprises at least two wheel seats, a driving wheel, a driven wheel, a conveyor belt and a first driver;
the at least two wheels seat are arranged on the centering base; the gap is formed between adjacent two of the at least two wheel seats; each of the at least two wheel seats is rotatably provided with the driving wheel and the driven wheel; the driving wheel is synchronously and rotatably connected with the driven wheel through the conveyor belt; an output end of the first driver is connected with the driving wheel, and is configured to drive the driving wheel to rotate, so as to drive the conveyor belt to rotate;
the first driving assembly comprises a driving base, a driving shaft, a plurality of driving rollers and a second driver; and
the driving base is arranged in the gap; an output end of the lifting assembly is connected with driving base, and is configured to drive the driving base to move up and down; the driving shaft is rotatably arranged on the driving base; the plurality of driving rollers are arranged on the driving shaft; an output end of the second driver is connected with the driving shaft, and is configured to drive the driving shaft to rotate, so as to drive the plurality of driving rollers to rotate.

In an embodiment, the cooling device comprises a placement base and a receiving assembly;
a conveying end of the receiving assembly is configured to move horizontally between the placement base and the conveying end of the placement mechanism;
the receiving assembly comprises a second driving assembly, a first gripper and a third driving assembly; and
an output end of the second driving assembly is connected with the first gripper, and is configured to drive the first gripper to move up and down; and
an output end of the third driving assembly is connected with the second driving assembly, and is configured to drive the second driving assembly to move horizontally, so as to drive the first gripper to move horizontally between the placement base and the conveying end of the placement mechanism.

In an embodiment, the cooling device further comprises an angle adjustment mechanism;
the placement mechanism, the angle adjustment mechanism and the placement base are arranged in sequence along the conveying direction of the artificial stone;
the angle adjustment mechanism comprises a fixing base, a rotating base and a third driver;
the rotating base is rotatably arranged on the fixing base; and an output end of the third driver is connected with the rotating base, and is configured to drive the rotating base to rotate relative to the fixing base; and
the third driving assembly is configured to drive the first gripper to move horizontally between the placement mechanism, the angle adjustment mechanism and the placement base.

In an embodiment, the artificial stone inkjet processing line further comprises a discharging mechanism;
the centering device, the inkjet printing device, the drying device, the cooling device and the discharging mechanism are arranged in sequence;
the discharging mechanism comprises a discharger, a fourth driving assembly, a second gripper and a fifth driving assembly; and
an output end of the fourth driving assembly is connected with the second gripper, and is configured to drive the second gripper to move up and down; an output end of the fifth driving assembly is connected with the fourth driving assembly, and is configured to drive the fourth driving assembly to move horizontally, so as to drive the second gripper to move horizontally between the placement base and the discharger.

In an embodiment, the placement mechanism comprises a base frame, a lifting frame, a sixth driving assembly, a seventh driving assembly and a picking assembly; and
the sixth driving assembly is arranged on the base frame; an output end of the sixth driving assembly is connected with the lifting frame, and is configured to drive the lifting frame to move up and down with respect to the base frame, so as to adjust the lifting frame to align with the outlet of the conveying end of the first conveying assembly, the storage station or the inlet of the conveying end of the cooling device; and
the third driving assembly is arranged on the lifting frame; a conveying end of the seventh driving assembly is configured to horizontally transfer the artificial stone to the storage station; the picking assembly comprises a picker, and the picker is configured to move in a resettable manner; and the picking assembly is movably arranged on the lifting frame, and is configured to reciprocate between the storage station and the conveying end of the seventh driving assembly.

In an embodiment, the heating box comprises a box body, a heating air duct assembly and an air guide plate;
the box body is provided with a drying storage chamber and an air-inlet chamber; and the drying storage chamber is separated from the air-inlet chamber through a partition plate;
the heating air duct assembly comprises an air-inlet duct and an air heating device; an output end of the air-inlet duct is communicated with a first end of the air-inlet chamber in a length direction; and the air-inlet chamber has a plurality of output ends, which are provided on the partition plate, and are distributed along a length direction of the partition plate; and the plurality of output ends of the air-inlet chamber are communicated with the drying storage chamber; and the air heating device is provided on the air-inlet duct for heating; and
the air guide plate is provided at the air-inlet chamber; a first end of the air guide plate is arranged on the first end of the air-inlet chamber in the length direction, and a second end of the air guide plate is arranged on a second end of the air-inlet chamber in the length direction; an air guide channel is formed between the partition plate and the air guide plate; and an inner diameter of the air guide channel is decreasing in a direction away from the air-inlet duct.

In an embodiment, the heating box comprises an elastic buffer part;
the elastic buffer part comprises a fixing portion and an elastic portion; and
the fixing portion is arranged in the drying storage chamber; the elastic portion is provided in a suspended manner; the elastic portion is elastic, and is provided with an arc-shaped buffering surface.

Compared to the prior art, the present disclosure has the following beneficial effects.

The artificial stone inkjet processing line is provided, where the artificial stone is centered and positioned by the centering device, and is printed through the inkjet printing device followed by heating in the heating box, and then is transferred to the placement mechanism through the first conveying assembly at the transition station. The placement mechanism is configured to receive the artificial stone and output it to the heating box or the cooling device, so that the artificial stone after inkjet printing can be flexibly subjected to drying or direct cooling, which solves problems of blocking of the processing line caused by some artificial stones after inkjet printing that need to be dried.

### BRIEF DESCRIPTION OF THE DRAWINGS

FIG. 1 is a structural diagram of an inkjet processing line for artificial stones according to an embodiment of the present disclosure.

FIG. 2 is a structural diagram of a drying device according to an embodiment of the present disclosure.

FIG. 3 is a structural diagram of a centering device according to an embodiment of the present disclosure.

FIG. 4 is a structural diagram of a drying device according to an embodiment of the present disclosure.

FIG. 5 is an enlarged view of portion “A” shown in FIG. 4.

FIG. 6 is a top view of the drying device according to an embodiment of the present disclosure.

In Figures: centering device 1; inkjet printing device 2; drying device 3; cooling device 4; pre-treating device 5; and discharging mechanism 6;
first conveying assembly 31; heating box 32; and placement mechanism 33;
transition station 320; and storage station 3261;
base frame 331; lifting frame 332; sixth driving assembly 333; seventh driving assembly 334; and picking assembly 335;
pre-treating chamber 51;
centering base 11; second conveying assembly 12; lifting assembly 13; first driving assembly 14; and positioning component 15;
wheel seat 121; driving wheel 122; driven wheel 123; conveyor belt 124; first driver 125; and gap 120;
driving base 141; driving shaft 142; driving roller 143; and second driver 144;
placement base 41; receiving assembly 42; and angle adjustment mechanism 43;
second driving assembly 421; first gripper 422; and third driving assembly 423;
fixing base 431; rotating base 432; and third driver 433; and
discharge 61; fourth driving assembly 62; second gripper 63; and fifth driving assembly 64.

### DETAILED DESCRIPTION OF EMBODIMENTS

The embodiments of the present disclosure will be described in detail below with reference to the accompanying drawings, where identical or similar reference numerals indicate identical or similar elements or elements having identical or similar functions. The embodiments described below are only exemplary and illustrative, and are not intended to limit the disclosure.

In the disclosure, it should be noted that the terms, such as “central”, “longitudinal”, “transverse”, “lengthwise”, “widthwise”, “thickness”, “up”, “down”, “left”, “right”, “front”, “rear”, “vertical”, “horizontal”, “top”, “bottom”, “inner”, “outer”, “inside”, “outside”, “inner end”, “outer end”, “axial”, “radial”, and “circumferential”, are only used for illustrating relative position relationship and motion between components in a specific state (as shown in the accompanying drawings), rather than limiting the disclosure. In addition, a feature defined with “first” or “second” may explicitly or implicitly indicates the inclusion of at least one of such features without implying order and importance. As used herein, “multiple” means two or more unless otherwise clearly stated.

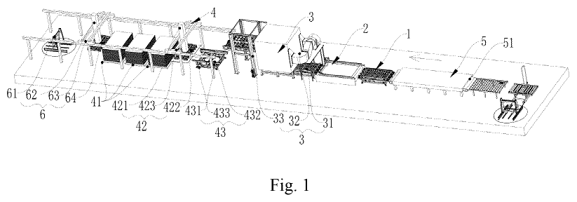

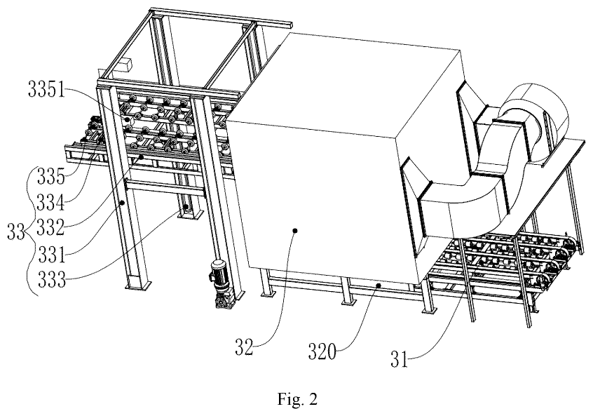

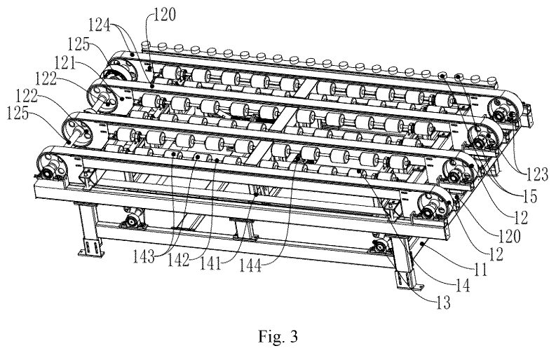

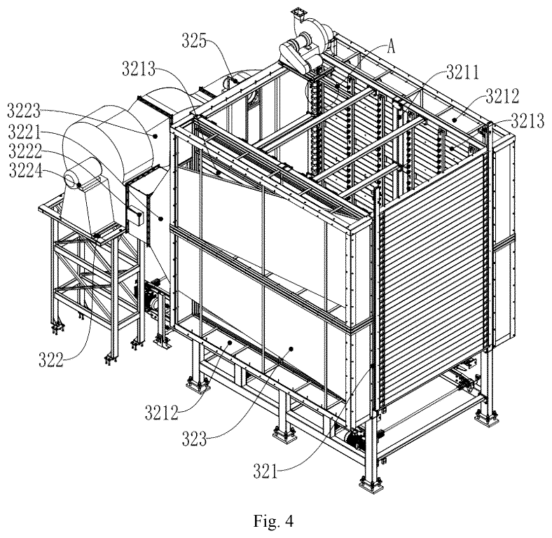

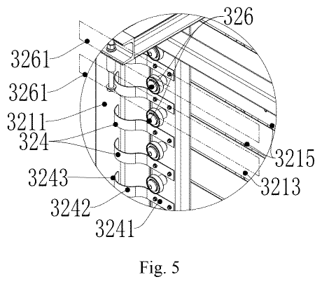

Referring to FIGS. 1-6, an inkjet processing line for artificial stones is provided, which includes a centering device 1, an inkjet printing device 2, a drying device 3 and a cooling device 4 arranged in sequence along a conveying direction of an artificial stone.

The inkjet printing device 2 is configured to perform inkjet printing. The centering device 1 has two conveying ends, one of which faces towards the inkjet printing device 2. A conveying direction of one of the two conveying ends is perpendicular to that of the other of the two conveying ends.

The drying device 3 includes a first conveying assembly 31, a heating box 32 and a placement mechanism 33.

The heating box 32 is provided with a transition station 320 with two hollow ends. One of the two hollow ends of the transition station 320 is configured to face towards the inkjet printing device 2, and the other one of the two hollow ends of the transition station 320 is configured to face towards the placement mechanism 33. A side of the heating box 32 towards the placement mechanism 33 is provided with a storage station 3261. The first conveying assembly 31 is provided at the transition station 320. An inlet of a conveying end of the first conveying assembly 31 is arranged close to an outlet of a conveying end of the inkjet printing device 2. A conveying end of the placement mechanism 33 is configured to be adjusted to align with an outlet of the conveying end of the first conveying assembly 31, the storage station 3261 or an inlet of a conveying end of the cooling device 4, and the conveying end of the placement mechanism 33 is configured to reciprocate between the heating box 32 and the cooling device 4.

The inkjet processing line is provided, where the artificial stone is centered and positioned by the centering device 1, and is printed through the inkjet printing device 2 followed by heating in the heating box 32, and then is transferred to the placement mechanism 33 through the first conveying assembly 31 at the transition station 320. The placement mechanism 33 is configured to receive the artificial stone and output it to the heating box 32 or the cooling device 4, so that the artificial stone after inkjet printing can be flexibly subjected to drying or direct cooling, which solves problems of blocking of the processing line caused by some artificial stones after inkjet printing that need to be dried.

In an embodiment, the artificial stone can be directly transferred to the artificial stone inkjet processing line, or can be transferred through a tray. Referring to FIG. 1, an arrow direction is the conveying direction of the artificial stone. The artificial stone is transferred to the centering device 1. The centering device 1 includes the first conveying end and the second conveying end. The first conveying end is configured to face towards the inkjet printing device 2, and is configured to output the artificial stone to the inkjet printing device 2. The second conveying end is perpendicular to the conveying direction of the artificial stone, and is configured to center the artificial stone, so that the artificial stone enters the inkjet printing device 2 in an optimal position, and then the artificial stone is transferred through the first conveying assembly 31 and the placement mechanism 33 based on a centered position, and then is set on the heating box 32 or the cooling device 4 through the placement mechanism 33. The heating box 32 is provided with the transition station 320 with the two hollow ends. The first end of the transition station 320 is communicated with the inkjet printing device 2, and the first conveying assembly 31 can receive the artificial stone at the first end of the transition station 320. The conveying end of the placement mechanism 33 after adjustment by lifting can vertically pass through the second end of the transition station 320, so as to receive the artificial stone from the first conveying assembly 31. After the placement mechanism 33 receiving the artificial stone, the artificial stone can be output to the heating box 32 for drying according to processing need of the artificial stone, or the artificial stone can be directly output to the cooling device 4 for cooling, or the artificial stone can be output to the heating box 32 for drying followed by cooling in the cooling device 4. In this way, the artificial stone can be subjected to drying or cooling after printing. If the artificial stone needs to be drying, it only needs to reverse the conveying end of the placement mechanism 33, and then the artificial stone is transferred to the storage station 3261 of the heating box 32. If the conveying end of the placement mechanism 33 is in a forward direction, the placement mechanism 33 moves in a direction away from the heating box 32, therefore, the drying of the artificial stone will not interfere other artificial stones to enter the cooling device 4, which avoids blocking of the processing line caused by some artificial stones during drying. In addition, the processing line achieves flexible use of the heating box 32 and the cooling device 4, and uses of the drying device 3 and the cooling device 4 do not interfere with each other, which improves the processing efficiency of the artificial stone inkjet processing line.

In an embodiment, the conveying end of the inkjet printing device 2, a conveying end of the centering device 1, the conveying end of the first conveying assembly 31 and the conveying end of the placement mechanism 33 respectively can be a main mechanism for realizing linear movement. For example, the linear movement can be realized by mechanisms with a function of driving linear movement, such as a conveyor belt structure, a conveyor roller structure, a combination of a gear and a chain, a travelling car, an air cylinder, an oil cylinder, a mechanical arm or a combination of an electrical machinery and a screw rod. An inlet of a conveying end is a position where the artificial stone enters the conveying end, and an outlet of the conveying end is a position where the artificial stone exits the conveying end.

In an embodiment, the artificial stone inkjet processing line further includes a pre-treating device 5.

The pre-treating device 5, the centering device 1, the inkjet printing device 2, the drying device 3 and the cooling device 4 are arranged in sequence.

The pre-treating device 5 is provided with a pre-treating chamber 51, and a heating mechanism and an impurity-removing mechanism are provided in the pre- treating chamber 51.

The heating mechanism is provided in the pre-treating chamber 51, and is configured to heat the artificial stone, so that the artificial stone has a certain temperature, which avoids influence on the ink caused by low temperature when the artificial stone enters the inkjet printing device 2, and ensures the ink is printed at an optimal temperature. The impurity-removing mechanism is configured to clean a surface of the artificial stone, so as to maintain a certain degree of cleanliness and prevent the ink from being applied on impurities. For example, dust on the surface of the artificial stone is sucked away by negative pressure. The heating mechanism and the impurity-removing mechanism can be arranged in the pre-treating chamber 51 according to needs.

In an embodiment, the centering device includes a centering base 11, a second conveying assembly 12, a lifting assembly 13 and a first driving assembly 14.

The second conveying assembly 12 is arranged on the centering base 11. The second conveying assembly 12 has at least two conveying ends facing towards the inkjet printing device 2. The at least two conveying ends of the second conveying assembly 12 are spaced apart from each other, such that a gap 120 is formed between adjacent two of the at least two conveying ends of the second conveying assembly 12.

The lifting assembly 13 and the first driving assembly 14 are arranged within the gap 120. A conveying end of the lifting assembly 13 is connected with the first driving assembly 14, and is configured to drive the first driving assembly 14 to rise to a position above or below the at least two conveying ends of the second conveying assembly 12. A conveying end of the first driving assembly 14 is configured to extend laterally, and is perpendicular to the at least two conveying ends of the second conveying assembly 12. The centering base 11 includes a positioning component 15, and the positioning component 15 is arranged at an outlet of the conveying end of the first driving assembly 14.

The conveying end of the second conveying assembly 12 is configured to face towards the inkjet printing device 2, and is configured to transfer the artificial stone in a direction towards the inkjet printing device 2. In an embodiment, the second conveying assembly 12 is provided with of the at least two conveying ends, and the gap 120 is formed between adjacent two conveying ends of the at least two conveying ends the second conveying assembly 12, so that the lifting assembly 13 and the first driving assembly 14 are configured to be arranged on the gap 120 between adjacent two conveying ends of the at least two conveying ends of the second conveying assembly 12. In an initial state, the lifting assembly 13 and the first driving assembly 14 are located in the gap 120, and the artificial stone can be normally transferred to the conveying end of the second conveying assembly 12. When the artificial stone is needed to be centered, the lifting assembly 13 is started to drive the first driving assembly 14 to move upward, so that the first driving assembly 14 lifts and extends to the position above the conveying end of the second conveying assembly 12, and the conveying end of the first driving assembly 14 supports the artificial stone. The first driving assembly 14 is started, and the conveying end of the first driving assembly 14 drives the artificial stone to move, so that the artificial stone moves towards an end of the conveying end of the first driving assembly 14. The artificial stone is contact with the positioning component 15 of the centering base 11 at the end of the conveying end of the first driving assembly 14, so that artificial stone is positioned to realize the centering of the artificial. Then the lifting assembly 13 drives the first driving assembly 14 to return downwards, and the artificial stone is re-placed on the conveying end of the second conveying assembly 12.

In an embodiment, the second conveying assembly 12, the lifting assembly 13 and the first driving assembly 14 can be replaced with mechanisms with the function of driving linear movement as long as the artificial stone realizes the linear movement.

In an embodiment, the second conveying assembly 12 includes at least two wheel seats 121, a driving wheel 122, a driven wheel 123, a conveyor belt 124 and a first driver 125.

The at least two wheel seats 121 are arranged on the centering base 11. The gap 120 is formed between adjacent two of the at least two wheel seats 121. Each of the at least two wheel seats 121 is provided with the driving wheel 122 and the driven wheel 123. The driving wheel 122 is synchronously and rotatably connected with the driven wheel 123 through the conveyor belt 124. An output end of the first driver 125 is connected with the driving wheel 122, and is configured to drive the driving wheel 122 to rotate, so as to drive the conveyor belt 124 to rotate.

The first driving assembly 14 includes a driving base 141, a driving shaft 142, a plurality of driving rollers 143 and a second driver 144.

The driving base 141 is arranged in the gap 120. An output end of the lifting assembly 13 is connected with driving base 141, and is configured to drive the driving base 141 to move up and down. The driving shaft 142 is rotatably arranged on the driving base 141. The plurality of driving rollers 143 is configured as a plurality of driving rollers 143 that arranged on the driving shaft 142. An output end of the second driver 144 is connected with the driving shaft 142, and is configured to drive the driving shaft 142 to rotate, so as to drive the plurality of driving rollers 143 to rotate.

In an embodiment, the artificial stone is transferred by the conveyor belt 124. In an embodiment, the at least two wheel seats 121 spaced apart from each other are installed in the centering base 11. The driving wheel 122 and the driven wheel 123 are installed in each of the at least two wheel seats 121, and the driving wheel 122 and the driven wheel 123 are synchronously and rotatably connected through the conveyor belt 124. When the first driver 125 is started, the conveying end of the first driver 125 drives the driving wheel 122 to rotate. Under the synchronous action of the conveyor belt 124, the driven wheel 123 rotates to make the conveyor belt 124 to rotate, so that the artificial stone on the conveyor belt 124 moves in a direction towards the inkjet printing device 2.

The first driver 125 can be a mechanism with a function of driving for rotation, such as a motor or a combination of a motor and a deceleration machine. Part of first drivers can be the mentioned motor, and the other part of the first drivers can be a synchronizing shaft structure. The synchronizing shaft structure is configured to connect one driving wheel 122 with the motor to another driving wheel 122, so that a plurality of driving wheels 122 rotate synchronously. An individual driving wheel 122 drives other driving wheels 122 to rotate, so as to drive the plurality of driving wheels 122 to rotate, and the plurality of driving wheels 122 rotate synchronously.

In an embodiment, the driving shaft 142 is configured to drive the plurality of driving rollers 143 to rotate. The first driving assembly 14 is configured as a plurality of first driving assemblies 14. An individual first driving assembly 14 is arranged on the gap 120 formed between different wheel seats 121. The at least two wheel seats 121 is configured as a plurality of wheel seats 121. When the artificial stone is need to be centered, the second driver 144 is started, and the second driver 144 drives the driving shaft 142 to rotate, so as to drive the plurality of driving rollers 143 of the driving shaft 142 to rotate, in this way, the artificial stone moves in a direction perpendicular to the conveying direction of the second conveying assembly 12, so that the artificial stone abuts against the positioning component 15 and is positioned. In an embodiment, the individual first driving assembly 14 can be replaced with a mechanism with a function of driving for rotation, such as a motor or a combination of a motor and a deceleration machine. The other first driving assemblies 14 can be a synchronizing belt structure. The synchronizing belt structure is configured to synchronously connect the driving shafts 142 of the plurality of first driving assemblies 14.

In an embodiment, the cooling device 4 includes a placement base 41 and a receiving assembly 42.

A conveying end of the receiving assembly 42 is configured to move horizontally between the placement base 41 and the conveying end of the placement mechanism 33.

The receiving assembly 42 includes a second driving assembly 421, a first gripper 422 and a third driving assembly 423.

An output end of the second driving assembly 421 is connected with the first gripper 422, and is configured to drive the first gripper 422 to move up and down. An output end of the third driving assembly 423 is connected with the second driving assembly 421, and is configured to drive the second driving assembly 421 to move horizontally, so as to drive the first gripper 422 to move horizontally between the placement base 41 and the conveying end of the placement mechanism 33.

The receiving assembly 42 is configured to pick up the artificial stone from the conveying end of the placement mechanism 33, where the artificial stone can be dried or undried. When the artificial stone reaches an outlet of the conveying end of the placement mechanism 33, the receiving assembly 42 can be started, the conveying end of the receiving assembly 42 moves to a position of the artificial stone, and the receiving assembly 42 receive the artificial stone and transfer the artificial stone to the placement base 41. In an embodiment, artificial stones can be stacked on the placement base 41, so that the artificial stone are cooled naturally. In an embodiment, a device with a cooling function, such as a fan, can be installed on the placement base 41.

In an embodiment, the first gripper 422 can be driven to move vertically and horizontally through a linkage of the second driving assembly 421 and the third driving assembly 423, so that the first gripper 422 can pass between the placement base 41 and the placement mechanism 33 during the horizontal movement, and grip or release the artificial stone during the vertical movement.

The second driving assembly 421 can be replaced with a mechanism with a function of driving for linear lifting, such as a lifter. The third driving assembly 423 can be a mechanism with a function of driving for horizontal movement, such as an air cylinder, an oil cylinder and a travelling car. The first gripper 422 can be a mechanism with a function of gripping, such as a mechanical arm, a clamp and a suction cup structure.

In an embodiment, the cooling device 4 further includes an angle adjustment mechanism 43.

The placement mechanism 33, the angle adjustment mechanism 43 and the placement base 41 are arranged successively along the conveying direction of the artificial stone.

The angle adjustment mechanism 43 includes a fixing base 431, a rotating base 432 and a third driver 433.

The rotating base 432 is rotatably arranged on the fixing base 431. An output end of the third driver 433 is connected with rotating base 432, and is configured to drive the rotating base 432 to rotate relative to the fixing base 431.

The third driving assembly 423 is configured to drive the first gripper 422 to move horizontally between the placement mechanism 33, the angle adjustment mechanism 43 and the placement base 41.

In an embodiment, the angle adjustment mechanism 43 is provided between the placement mechanism 33 and the placement base 41. The artificial stone is transferred from the placement mechanism 33 to the third driving assembly 423 through the first gripper 422, then the third driver 433 is started, and the third driver 433 drives the rotating base 432 to rotate, so as to drive the artificial stone on the rotating base 432 to rotate, in this way, the artificial stone rotates at a specific angle, so that the artificial stone can be gripped by the first gripper 422 at an optimal angle, which facilitates the placement base 41 to stack the artificial stone at the optimal angle.

In an embodiment, the artificial stone inkjet processing line further includes a discharging mechanism 6.

The centering device 1, the inkjet printing device 2, the drying device 3, the cooling device 4 and the discharging mechanism 6 arranged in sequence.

The discharging mechanism 6 includes a discharger 61, a fourth driving assembly 62, a second gripper 63 and a fifth driving assembly 64.

An output end of the fourth driving assembly 62 is connected with the second gripper 63, and is configured to drive the second gripper 63 to move up and down. An output end of the fifth driving assembly 64 is connected with the fourth driving assembly 62, and is configured to drive the fourth driving assembly 62 to move horizontally, so as to drive the second gripper 63 to move horizontally between the placement base 41 and the discharger 61.

The second gripper 63 is driven to move vertically and horizontally through a linkage of the fourth driving assembly 62 and the fifth driving assembly 64, so that the second gripper 63 can pass between the placement base 41 and the discharger 61 during the horizontal movement, and grip or release the artificial stone during the vertical movement, so that the second gripper 63 can place the discharger 61 after gripping the artificial stone at the discharger 61.

The fourth driving assembly 62 can be replaced with a mechanism with a function of driving for linear lifting, such as a lifter. The fifth driving assembly 64 can be a mechanism with a function of driving for horizontal movement, such as an air cylinder, an oil cylinder and a travelling car. The second gripper 63 can be a mechanism with a function of gripping, such as a mechanical arm, a clamp and a suction cup structure.

In an embodiment, the placement mechanism 33 includes a base frame 331, a lifting frame 332, a sixth driving assembly 333, a seventh driving assembly 334 and a picking assembly 335.

The sixth driving assembly 333 is arranged on the base frame 331. An output end of the sixth driving assembly 333 is connected with the lifting frame 332, and is configured to drive the lifting frame 332 to move up and down with respect to the base frame 331, so that the lifting frame 332 is configured to align with the outlet of the conveying end of the first conveying assembly 31, the storage station 3261 or the inlet of the conveying end of the cooling device 4. The third driving assembly 423 is arranged on the lifting frame 332. A conveying end of the seventh driving assembly 334 is configured to horizontally transfer the artificial stone to the storage station. The picking assembly 335 includes a picker 3351, and the picker 3351 is configured to move in a resettable manner. The picking assembly 335 is movably arranged on the lifting frame 332, and is configured to reciprocate between the storage station 3261 and the conveying end of the seventh driving assembly 334.

When a mold needs to be stored, the sixth driving assembly 333 is started to drive the lifting frame 332 to move to a position at a height for receiving the mold. The mold is placed at a center of the lifting frame 332 by hand or the seventh driving assembly 334. The sixth driving assembly 333 is started again to drive the lifting frame 332 to move to the storage station 3261 which is unoccupied, and then the seventh driving assembly 334 is started. The seventh driving assembly 334 drives the mold to transferred in a forward direction towards the storage station 3261, so that the mold is placed in the storage station 3261. When the mold needs to be picked up, the sixth driving assembly 333 drives the lifting frame 332 to move to a position at a required height of the mold. The picking assembly 335 is started to move horizontally to the position of the mold, and the picker 3351 with a function of gripping extends out, and the picker 3351 is configured to pick up the mold. The mold is transferred to the conveying end of the seventh driving assembly 334 in the lifting frame 332 under the action of return and dragging of the picking assembly 335, and the mold is driven to be output under the action of reverse transferring of the seventh driving assembly 334, so as to realize the picking of the mold from the heating box 32.

In an embodiment, the sixth driving assembly 333 can be replaced with a mechanism with a function of driving for lifting, such as an air cylinder, an oil cylinder a combination of a motor and a screw and a mechanical arm, as long as it can realize that the lifting frame 332 moves up and down along the base frame 331. The seventh driving assembly 334 can be replaced with a mechanism with a function of driving for horizontal movement, such as an air cylinder, an oil cylinder, a travelling car, a conveyor roller structure and a conveyor belt structure, as long as it can realize that the mold moves horizontally along the lifting frame 332. The picking assembly 335 moves horizontally along the lifting frame 332, and can be realized by a mechanism with a function of driving for horizontal movement, such as an air cylinder, an oil cylinder, a travelling car, a conveyor roller structure and a conveyor belt structure, as long as it can realize that the picking assembly 335 moves horizontally along the lifting frame 332. The picker 3351 can be replaced with a mechanism with a function of picking, such as a fixture, a clamp and a mechanical arm.

In an embodiment, the heating box 32 includes a box body 321, a heating air duct assembly 322 and an air guide plate 323.

The box body 321 is provided with a drying storage chamber 3211 and an air- inlet chamber 3212. The drying storage chamber 3211 is separated from the air-inlet chamber 3212 through a partition plate 3213.

The heating air duct assembly 322 includes a air-inlet duct 3221 and an air heating device 3222.

An output end of the air-inlet duct 3221 is communicated with a first end of the air-inlet chamber 3212 in a length direction. The air-inlet chamber 3212 has a plurality of output ends, which are provided on the partition plate 3213, and are distributed along a length direction of the partition plate 3213. The plurality of output ends of the air-inlet chamber 3212 are communicated with the drying storage chamber 3211. The air heating device 3222 is provided on the air-inlet duct 3221 for heating.

The air guide plate 323 is provided at the air-inlet chamber 3212. A first end of the air guide plate 323 is arranged on the first end of the air-inlet chamber 3212 in the length direction, and a second end of the air guide plate 323 is arranged on a second end of the air-inlet chamber 3212 in the length direction. An air guide channel 3214 is formed between the partition plate 3213 and the air guide plate 323. An inner diameter of the air guide channel 3214 is decreasing in a direction away from the air-inlet duct 3221.

In an embodiment, the heating box 32 is provided, and is configured to arranged the air guide plate 323 in the air-inlet chamber 3212 connected with the drying storage chamber 3211. An inner diameter of the air-inlet chamber 3212 is changed through the air guide plate 323, so that the inner diameter of the air guide channel 3214 is decreasing, so as to change a flow rate of an air flow along a length direction. The flow rate of the air flow is gradually improved, so that the air nearly synchronously enters the drying storage chamber 3211 along a length direction, in this way, the drying storage chamber 3211 is more uniform during drying, which solves the problem of uneven drying caused by the heating box 32 enters an interior from one side.

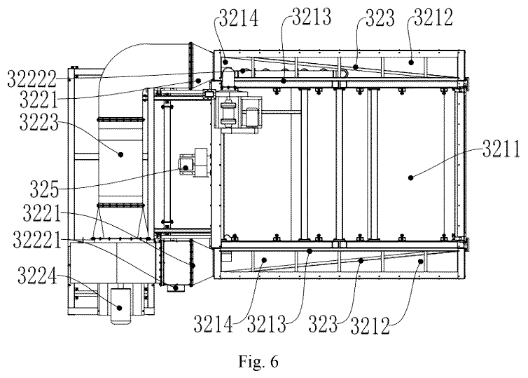

In an embodiment, the box body 321 is provided with the drying storage chamber 3211 and the air-inlet chamber 3212. The drying storage chamber 3211 is a main drying area, which is configured to support a structure, such as a stand, a tray and a riding wheel of a drying material. Referring to FIG. 6, the air-inlet chamber 3212 is configured to output a heating air to the drying storage chamber 3211. An end of the air-inlet chamber 3212 in the length direction is connected with the air-inlet duct 3221, and the air-inlet duct 3221 is configured to output the air to the air-inlet chamber 3212. After the air passes through the air heating device 3222, and the air heating device 3222 is configured to heat the air, so that the air is heated and then is output to the air-inlet chamber 3212. The air-inlet chamber 3212 is provided with the air guide plate 323, the air guide plate 323 tilts and extends along the length direction, that is, the first end of the air guide plate 323 is arranged on the first end of the air-inlet chamber 3212 in the length direction, and the second end of the air guide plate 323 is arranged on a second end of the air-inlet chamber 3212 in the length direction. The air guide plate 323 in the air-inlet chamber 3212 can change the inner diameter of the air-inlet chamber 3212, and the air guide channel 3214 is formed between the air guide plate 323 and the partition plate 3213, and the inner diameter of the air guide channel 3214 is decreasing in the direction away from the air-inlet duct 3221. Because the air guide channel 3214 is communicated with the air-inlet duct 3221, the heating air in the air-inlet duct 3221 is heated and then is output to the air guide channel 3214. Based on constant flux of the air flow, the inner diameter of the air guide channel 3214 is decreasing in the direction away from the air-inlet duct 3221, the flow rate of the air flow is gradually decreased along the length direction, so that the air quickly passes through conveying ends of a plurality of air-inlet chambers 3212 at the partition plate 3213, and then passes through conveying ends of a plurality of partition plates 3213 to the drying storage chamber 3211. In this way, the air flow can be nearly synchronously output to the drying storage chamber 3211 along the length direction, and be nearly synchronously output to multiple positions of partition plate 3213 rather than concentrating on a local position, which further improves a heating uniformity of the air flow, solves the problem of uneven drying caused by the heating box 32 enters the interior from one side.

The air heating device 3222 can be a mechanism with a heating function, such as resistance wire heating, electromagnetic heating and water bath heating. An output end of the air-inlet chamber 3212 can be a mechanism with a function of outputting air, such as a through hole, a through groove and a nozzle.

The plurality of air-inlet chambers 3212 are configured to be provided on at least two sides of the drying storage chamber 3211, an individual air-inlet chamber 3212 is correspondingly connected with communicated with an individual air-inlet duct 3221.

In an embodiment, a plurality of sides of the drying storage chamber 3211 are provided with the air-inlet chamber 3212, the individual air-inlet chamber 3212 is correspondingly connected with communicated with the individual air-inlet duct 3221, when the heating air enters the plurality of sides of the drying storage chamber 3211, based on the air guide channel 3214 provided in the air-inlet chamber 3212, the heating air can nearly synchronously enter the plurality of sides of the drying storage chamber 3211 along the length direction, so as to further improve the drying uniformity of the drying storage chamber 3211.

The air heating device 3222 is divided into a resistance heating device 32221 and a gas heating device 32222. The number of the air-inlet chamber 3212 is two. One air-inlet duct 3221 connected with one of the two air-inlet chambers 3212 is provided with the resistance heating device 32221, and another air-inlet duct 3221 connected with the other one of the two air-inlet chambers 3212 is provided with the gas heating device 32222.

The air heating device 3222 is divided into the resistance heating device 32221 and the gas heating device 32222 according to needs. The resistance heating device 32221 is configured to generate heat through electric current passing through a conductive material to heat the air form the air-inlet duct 3221, which has high heating stability. The gas heating device 32222 is configured to heat the air through utilizing a combustible gas, which high heat generation, and is suitable for processes with high drying degree and drying speed.

The heating air duct assembly 322 includes an air intake duct 3223 and an air extraction device 3224.

A first output end of the air intake duct 3223 is communicated with the air- inlet duct 3221 provided with the resistance heating device 32221, and a second output end of the air intake duct 3223 is communicated with the air-inlet duct 3221 provided with the gas heating device 32222. The air extraction device 3224 is provided on the air intake duct 3223.

In an embodiment, the number of the air intake duct 3223 is one, and the air intake duct 3223 simultaneously outputs the air flow to two air-inlet ducts 3221, that is, the two air-inlet ducts 3221 share one air extraction device 3224. One of the first output end and the second output end of the air intake duct 3223 can be opened according to needs, so that the air is fed into the air intake duct 3223 under the negative pressure of the air extraction device 3224, and the air is transferred to corresponding air-inlet duct 3221, and then is output to the air guide channel 3214 through the air-inlet duct 3221, which simplifies the number and structure of air-inlet ducts.

In an embodiment, the heating box 32 further includes an elastic buffer part 324.

The elastic buffer part 324 is provided with a fixing portion 3241 and an elastic portion 3242.

The fixing portion 3241 is arranged in the drying storage chamber 3211. The elastic portion 3242 is provided in a suspended manner. The elastic portion 3242 has elasticity, and is provided with a arc-shaped buffering surface 3243.

When an object placed in the drying storage chamber 3211, the elastic buffer part 324 is configured to provide a buffer function for the object when it moves into the drying storage chamber 3211. A movement end of the object in the drying storage chamber 3211 abuts against the elastic buffer part 324. The elastic buffer part 324 is provided with the fixing portion 3241 and the elastic portion 3242. The fixing portion 3241 is configured to fix the elastic buffer part 324 on the drying storage chamber 3211. The elastic portion 3242 is provided in the suspended manner. The elastic buffer part 324 has elasticity, and can be made of a material with a certain elasticity, such as a metal, a plastic and a rubber. Because the elastic portion 3242 is provided in the suspended manner, when the object moves to abut against the elastic portion 3242, the elastic portion 3242 performs an elastic deformation, so as to decrease a speed of the object entering the drying storage chamber 3211, avoiding impact on an interior of the drying storage chamber 3211 caused by fast movement of the object.

The drying storage chamber 3211 is provided with a plurality of storage stations 3261 along a height direction, and each of the plurality of storage stations 3261 is provided with the elastic buffer part 324.

The drying storage chamber 3211 is provided with the plurality of storage stations 3261 along the height direction, the object can be arranged along a height direction of the drying storage chamber 3211, so that the air flow output from the air- inlet chamber 3212 can be output along the length direction, and the plurality of storage stations 3261 are heated whole and evenly.

An output end of the air-inlet chamber 3212 is provided with an air outlet 3215. The air outlet 3215 is distributed along the length direction and height direction of the partition plate 3213 and is communicated with the storage station 3261.

An output end of the air-inlet chamber 3212 is provided on the partition plate 3213, that is, the partition plate 3213 is provided with a plurality of air outlets 3215. The plurality of air outlets 3215 are distributed along the height direction of the partition plate 3213, so that an individual air outlet 3215 corresponds to an individual storage station 3261, and the air is output to different storage stations 3261. When the air enters the air-inlet chamber 3212, the air is accelerated to output to different positions of the individual storage station 3261 from the plurality of air outlets 3215 along the length direction, so that the length direction nearly synchronously contacts the air, which improves the heating uniformity of each storage station 3261.

The heating box 32 further includes a dehumidifying device 325. The dehumidifying device 325 is communicated with the drying storage chamber 3211.

In an embodiment, besides the drying storage chamber 3211 is heated by the heating air duct assembly 322, the dehumidifying device 325 is configured to extract the air in the drying storage chamber 3211 until a humidity in the drying storage chamber 3211 reaches a specified value, the heating air duct assembly 322 is started, which greatly improves the drying effect.

In an embodiment, the drying storage chamber 3211 is provided with a storage wheel 326. The storage wheel 326 is provided along the height direction of the drying storage chamber 3211. The storage station 3261 is formed between corresponding adjacent two storage wheels 326 in a vertical direction. The storage wheel 326 can be arranged on the drying storage chamber 3211, and the storage station 3261 is formed between corresponding adjacent two storage wheels 326 in the vertical direction to separate to form different storage stations 3261. At the same time, the storage wheel 326 can contact a lower part of the object, so that when the object enters or exits the storage station 3261, the storage wheel 326 is configured to provide a rolling effect, which improves a fluency of the object entering and exiting the storage station 3261.

Although the disclosure has been are described in detail with reference to the above embodiments, it should be understood by those of ordinary skill in the art that various changes, modifications and replacements without departing from the scope of the present disclosure shall fall within the scope of this application defined by the appended claims.

What is claimed is:

1. An inkjet processing line for artificial stones, comprising:
a centering device;
an inkjet printing device;
a drying device; and
a cooling device;
wherein the centering device, the inkjet printing device, the drying device and the cooling device are arranged in sequence along a conveying direction of an artificial stone;
the inkjet printing device is configured to perform inkjet printing;
the centering device comprises a first conveying end and a second conveying end;
the first conveying end is configured to face towards the inkjet printing device, and a conveying direction of the first conveying end is perpendicular to a conveying direction of the second conveying end;
the drying device comprises a first conveying assembly, a heating box and a placement mechanism;
the heating box is provided with a transition station with two hollow ends; and one of the two hollow ends of the transition station is configured to face towards the inkjet printing device, and the other of the two hollow ends of the transition station is configured to face towards the placement mechanism;
a side of the heating box towards the placement mechanism is provided with a storage station;
the first conveying assembly is provided at the transition station; an inlet of a conveying end of the first conveying assembly is arranged close to an outlet of a conveying end of the inkjet printing device; and
a conveying end of the placement mechanism is configured to be adjusted to align with an outlet of the conveying end of the first conveying assembly, the storage station or an inlet of a conveying end of the cooling device, and the conveying end of the placement mechanism is configured to reciprocate between the heating box and the cooling device.

2. The inkjet processing line of claim 1, further comprising:
a pre-treating device;
wherein the pre-treating device, the centering device, the inkjet printing device, the drying device and the cooling device are arranged in sequence; and
the pre-treating device is provided with a pre-treating chamber; and a heating mechanism and an impurity-removing mechanism are provided in the pre-treating chamber.

3. The inkjet processing line of claim 1, wherein the centering device comprises a centering base, a second conveying assembly, a lifting assembly and a driving assembly;
the second conveying assembly is arranged on the centering base; the second conveying assembly has at least two conveying ends facing towards the inkjet printing device; and the at least two conveying ends of the second conveying assembly are spaced apart from each other, such that a gap is formed between adjacent two of the at least two conveying ends of the second conveying assembly; and
the lifting assembly and the driving assembly are arranged within the gap; a conveying end of the lifting assembly is connected with the driving assembly, and is configured to drive the driving assembly to rise to a position above or below the at least two conveying ends of the second conveying assembly; a conveying end of the driving assembly is configured to extend laterally, and is perpendicular to the at least two conveying ends of the second conveying assembly; and the centering base comprises a positioning component, and the positioning component is arranged at an outlet of the conveying end of the driving assembly.

4. The inkjet processing line of claim 3, wherein the second conveying assembly comprises at least two wheel seats, a driving wheel, a driven wheel, a conveyor belt and a first driver;
the at least two wheel seats are arranged on the centering base; the gap is formed between adjacent two of the at least two wheel seats; each of the at least two wheel seats is rotatably provided with the driving wheel and the driven wheel; the driving wheel is synchronously and rotatably connected with the driven wheel through the conveyor belt; an output end of the first driver is connected with the driving wheel, and is configured to drive the driving wheel to rotate, so as to drive the conveyor belt to rotate;
the driving assembly comprises a driving base, a driving shaft, a plurality of driving rollers and a second driver; and
the driving base is arranged in the gap; an output end of the lifting assembly is connected with driving base, and is configured to drive the driving base to move up and down; the driving shaft is rotatably arranged on the driving base; the plurality of driving rollers are arranged on the driving shaft; an output end of the second driver is connected with the driving shaft, and is configured to drive the driving shaft to rotate, so as to drive the plurality of driving rollers to rotate.

5. The inkjet processing line of claim 1, wherein the cooling device comprises a placement base and a receiving assembly;
a conveying end of the receiving assembly is configured to move horizontally between the placement base and the conveying end of the placement mechanism;
the receiving assembly comprises a first driving assembly, a first gripper and a second driving assembly;
an output end of the first driving assembly is connected with the first gripper, and is configured to drive the first gripper to move up and down; and
an output end of the second driving assembly is connected with the first driving assembly, and is configured to drive the first driving assembly to move horizontally, so as to drive the first gripper to move horizontally between the placement base and the conveying end of the placement mechanism.

6. The inkjet processing line of claim 5, wherein the cooling device further comprises an angle adjustment mechanism;
the placement mechanism, the angle adjustment mechanism and the placement base are arranged in sequence along the conveying direction of the artificial stone;
the angle adjustment mechanism comprises a fixing base, a rotating base and a driver;
the rotating base is rotatably arranged on the fixing base; and an output end of the driver is connected with the rotating base, and is configured to drive the rotating base to rotate relative to the fixing base; and
the second driving assembly is configured to drive the first gripper to move horizontally between the placement mechanism, the angle adjustment mechanism and the placement base.

7. The inkjet processing line of claim 5, further comprising:
a discharging mechanism;
wherein the centering device, the inkjet printing device, the drying device, the cooling device and the discharging mechanism are arranged in sequence along the conveying direction of the artificial stone;
the discharging mechanism comprises a discharger, a third driving assembly, a second gripper and a fourth driving assembly; and
an output end of the third driving assembly is connected with the second gripper, and is configured to drive the second gripper to move up and down; an output end of the fourth driving assembly is connected with the third driving assembly, and is configured to drive the third driving assembly to move horizontally, so as to drive the second gripper to move horizontally between the placement base and the discharger.

8. The inkjet processing line of claim 1, wherein the placement mechanism comprises a base frame, a lifting frame, a first driving assembly, a second driving assembly and a picking assembly; and
the first driving assembly is arranged on the base frame; an output end of the first driving assembly is connected with the lifting frame, and is configured to drive the lifting frame to move up and down with respect to the base frame, so as to adjust the lifting frame to align with the outlet of the conveying end of the first conveying assembly, the storage station or the inlet of the conveying end of the cooling device;
the second driving assembly is arranged on the lifting frame; a conveying end of the second driving assembly is configured to horizontally transfer the artificial stone to the storage station; the picking assembly comprises a picker, and the picker is configured to move in a resettable manner; and the picking assembly is movably arranged on the lifting frame, and is configured to reciprocate between the storage station and the conveying end of the second driving assembly.

9. The inkjet processing line of claim 1, wherein the heating box comprises a box body, a heating air duct assembly and an air guide plate;
the box body is provided with a drying storage chamber and an air-inlet chamber;
and the drying storage chamber is separated from the air-inlet chamber through a partition plate;
the heating air duct assembly comprises an air-inlet duct and an air heating device;
an output end of the air-inlet duct is communicated with a first end of the air-inlet chamber in a length direction; and the air-inlet chamber has a plurality of output ends, which are provided on the partition plate, and are distributed along a length direction of the partition plate; and the plurality of output ends of the air-inlet chamber are communicated with the drying storage chamber; and the air heating device is provided on the air-inlet duct for heating; and
the air guide plate is provided at the air-inlet chamber; a first end of the air guide plate is arranged on the first end of the air-inlet chamber in the length direction, and a second end of the air guide plate is arranged on a second end of the air-inlet chamber in the length direction; an air guide channel is formed between the partition plate and the air guide plate; and an inner diameter of the air guide channel is decreasing in a direction away from the air-inlet duct.

10. The inkjet processing line of claim 9, wherein the heating box further comprises an elastic buffer part;
the elastic buffer part comprises a fixing portion and an elastic portion; and
the fixing portion is arranged in the drying storage chamber; the elastic portion is provided in a suspended manner; the elastic portion is elastic, and is provided with a arc-shaped buffering surface.
